(19) United States
(12) Patent Application Publication
(10) Pub. No.: US 2004/0095367 A1
(43) Pub. Date: May 20, 2004

(54) Virtual manipulation method of a digital content

(75) Inventors: Jen-Hwang Weng, Jungli City (TW); Ching-Mao Yeh, Miaoli (TW); Jung-Sheng Lin, Kaohsiung (TW); Shu-Chun Liu, Jungli City (TW); Po-Chao Huang, Jungli City (TW)

Correspondence Address: BRUCE H. TROXELL, SUITE 1404, 5205 LEESBURG PIKE, FALLS CHURCH, VA, 22041, US

(73) Assignee: Jen-Hwang Weng

(21) Appl. No.: 10/714,633

(22) Filed: Nov. 18, 2003

(30) Foreign Application Priority Data
Nov. 20, 2002 (TW) 91133785

(51) Int. Cl. G09G 5/00

(52) U.S. Cl. 345/700

(57) ABSTRACT

A method is provided to virtually manipulate a digital content. The digital content comprises at least one object. The object comprises at least one behavior. The method comprises steps of: (1) providing a visible driving object in the digital content, in which the visible driving object has a plurality of statuses and is able to actively change a current status; (2) designating the object according to a first status of the visible driving object; (3) designating the behavior according to a second status of the visible driving object; and (4) virtually manipulating the behavior of the object.

### BACKGROUND OF THE INVENTION

1. Field of the Invention

This present invention relates to a virtual manipulation method of a digital content, and especially to a method of virtually manipulating the digital content by a virtual figure.

2. Description of the Prior Art

A digital content is mostly manipulated by a user via an input device, such as a mouse, a keypad, a rocker, a photo pen or a voice input software etc. To make an object into a digital content, the object usually comprises an event, a method and a property. The user can use the input device to trigger the event of the object, to drive the method of the object, to acquire or change the property value of the object so as to achieve the goal of manipulating the digital content. In the art, the digital content is preferably to interact with the user in real time. The user can input his/her request to the digital content by any appropriate input device, and the digital content, on the other hand, would respond the request by triggering the event, driving the method or changing the property value. In particular, the digital content described above can be a digital document or a container of the digital document while the container can be a software.

### SUMMARY OF THE INVENTION

The primary object of this present invention is to add a virtual figure into a digital content, in which the virtual figure can present particular kinds of concrete actions. When the virtual figure makes an action, it can trigger an event, typically a pseudo event, of the object, drive a method of the object or change a property value of the object by a program already in the digital content. The method of using the program to manipulate the behavior of the object in the present invention is generally called a virtual manipulation. Though the method provided by the present invention is different in operation to the conventional method that uses input devices to manipulate the digital content, yet the same effect responded to the same request can be obtained by either way.

In a common digital content having interactions with the user, the interactive function of the digital content is always passive. That is, without user's input, no interacting effect would be generated. In the case that a request is sent to the digital content through the input device, the present invention utilizes a virtual figure to simulate the respective action of the user so as to animate the corresponding interacting effect of the digital content.

One of the best advantages of virtually manipulating the digital in accordance with the present invention is to actively present the signification of the digital content. The signification can comprise an image and a performing method of the digital content. For example, a virtual teacher can be arranged in an interactive teaching document of the digital content. A concrete action of the virtual teacher can be utilized to trigger the event, drive the method or change the property value in a virtual way by accompanying a respective teaching voice to perform the virtual teaching. Thereby, a student cannot only manipulate the teaching document to study by himself, but also can obtain benefit from the animate teaching of the virtual teacher in the same screen. Further, an operation instruction of the hardware can also be the action of the present invention. A respective virtual figure can be generated to demonstrate the operation process. Upon such an arrangement, the user can operate the hardware interface with the help of the virtual figure and can also understand much clearly the operation details of the hardware in response to the request. Equally, a PC game content, a PC animate content, a PC multimedia content, an operational instruction interface of software or a content of common web page and so on can also be digital contents to apply the method of the present invention.

Another object of the present invention is to provide a method of manipulating a digital content by a virtual way. The method of the present invention can create a virtual figure in the digital content. The virtual figure may have various statuses such as concrete appearances (such as action images, word suggestions, or colors) of the virtual figure, coordinate locations of the virtual figure, or voices assigned to the virtual figure. The statuses of the virtual figure are preferably used to manipulate the virtual figure to display respective behaviors of the object. Also, the present invention can use a virtual way to trigger the event of the object, to drive the method of the object, or to change the property value of the object. By providing the present invention, the signification or the operational framework of the digital content can be actively expressed. In the description of the present invention, a driving object will be utilized to demonstrate the virtual figure described above.

In one embodiment of the present invention, a virtual manipulating method can comprise the steps of:

1. providing a digital content comprising at least one object further comprising at least one behavior;

2. providing a visible driving object in the digital content, In which the visible driving object has a plurality of statuses and is able to actively change a current status according to a manipulation demand of the digital content;

3. providing a object-designating mechanism in the digital content, in which the object-desiganting mechanism can designate the object according to the status of the visible driving object;

4. providing a behavior-designating mechanism in the digital content, in which the behavior-designating mechanism designates the behavior according to the status of the visible driving object;

5. providing a virtual manipulation mechanism in the digital content to virtually manipulate the behavior of the object; and

6. while the visible driving object changing its status the object-designating mechanism designating an object, the behavior-designating mechanism designating a behavior, and the virtual manipulation mechanism virtually manipulating the behavior of the object.

Due to the behaviors of the object comprising events, methods, and properties, the behavior-designating mechanism can designate an event, a method, or a property. The virtual manipulating mechanism can virtually trigger the event of the object, drive the method of the object, acquire or change the property value of the object by similar reasons. Furthermore, the statuses of the visible driving object can comprise concrete appearancesvisible, coordinate locationsvisible, or voices visible. The appearances of the visible driving object can comprise an action image, a word suggestion or a color. To change the status of the visible driving object in this invention means to change its position, its appearance or its voicevisible.

The present invention can also be used to virtually manipulate a web page. One embodiment of the present invention is to provide a website system for virtually manipulating a web page. The web system can provide the web page and a respective visible driving object for downloading to a web browser of a client computer apparatus via internets. When the visible driving object changes statuses in the web page, the visible driving object can use a virtual way to trigger the event of the object, to drive the method of the object, to acquire or to change the property value of the object. The website system mentioned herein can comprise a communication interface, a CPU, a memory, an object mechanism, a behavior mechanism, and a virtual manipulation mechanism.

In the present invention, a communication interface can be used to connect the Internet for setting up a communication link with the client computer apparatus. A memory can be used to at least save the web page and the visible driving object. Typically, the web page comprises at least an object, and the object comprises at least a behavior. In particular, an event, a method and a property are three basic behaviors. The visible driving object has a plurality of statuses and is able to actively change statuses. To change the current status can simply mean to move the position of the visible driving object, to change the appearance of the visible driving object or to make the visible driving object pronounce another voice etc. Preferably, the visible driving object of the present invention can be downloaded to a web browser via the Internets.

In the present invention, the object-designating mechanism can be downloaded to the web browser via the communication link. The object-designating mechanism can be used to designate an object to the web page according to a status of the visible driving object.

Similarly, the behavior-designating mechanism can be downloaded to the web browser via the communication link. The behavior-designating mechanism is used to designate the behavior according to a second status of the visible driving object. Typical behaviors can include events, methods or properties. That is, the behavior-designating mechanism can be used to designate an event, a method or a property.

The virtual manipulation mechanism of the present invention can be downloaded to the web browser via the communication link. The virtual manipulation mechanism is used to virtually manipulate the behaviors of the objects included in the web page. Three basic kinds of the behaviors are events, methods and properties. Therefore, in the present invention, the virtual manipulation mechanism can be used to trigger the event of the web page, to drive a method of the web page, to acquire or to change a property value of the web page.

The advantage and spirit of the invention may be understood by the following recitations together with the appended drawings.

### BRIEF DESCRIPTION OF THE APPENDED DRAWINGS

FIG. 1 is a flowchart of a preferred embodiment of the virtually manipulation method of digital content in accordance with the present invention; and

FIG. 2 shows schematically a typical website system in accordance with the present invention.

### DETAILED DESCRIPTION OF THE INVENTION

The present invention is a method of manipulating a digital content by a virtual way. The digital content comprises at least an object. The object comprises at least a behavior. The present invention creates a visible driving object in the digital content. According to different statuses (such as different actions, different appearances, different voices or different positions etc.) of the visible driving object, the present invention uses a virtual way to trigger events of the object, to drive methods of the object, or to change property values of the object.

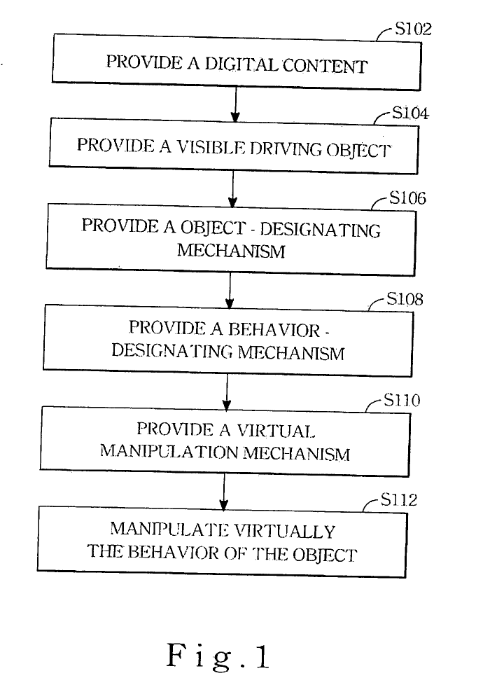

Referring now to FIG. 1, a preferred embodiment of the present invention comprises following steps;

Providing a digital content comprising at least one object, in which the object comprises at least one behavior; (Step S1102)

Providing a visible driving object in the digital content, in which the visible driving object has a plurality of statuses and is able to actively change a current status according to a manipulation demand of the digital content; (Step S104)

Providing an object-designating mechanism in the digital content, in which the object-designating mechanism designates the object according to the status of the visible driving object; (Step S106)

Providing a behavior-designating mechanism in the digital content, in which the behavior-designating mechanism designates the behavior according to the status of the visible driving object; (Step S108)

Providing a virtual manipulation mechanism in the digital content to virtually manipulate the behavior of the object; and (Step S110)

While the visible driving object changing the status, the object-designating mechanism re-designating an object, the behavior-designating mechanism re-designating a behavior, and the virtual manipulation mechanism virtually manipulating the behavior of the object. (Step S112)

In Step 102, the digital content means one of the followings: a teaching document, a PC game content, a PC animate content, a PC multimedia content, an operation instruction of a hardware, an operation instruction of a software, a web page content etc. Besides, the digital content can also be the container of the digital content, such as one of following software: a web browser, an e-book viewing software, a teaching assisting software, a paper work software, a trial balance software, a database software, a briefing software, an e-mail software, and a PC game software etc. By the way, there are at least three kinds of behaviors of the object: events, methods, and properties (or say, property values).

In Step 104, the statuses of the visible driving object may be a coordinate position of the visible driving object, a concrete appearance (such as an action image, a color, or a word suggestion) of the visible driving object, or a voice produced by the visible driving object. Changing the status of the visible driving object simply means to change its position, its appearance or its voice produced by the visible driving object etc. A program can be used to move the position of the visible driving object so as to change the position status of the visible driving object. The program also can be used to exchange various pictures or animations so as to change the appearance of the visible driving object. The visible driving object can be made as a multimedia object to directly present different appearances or different voice statuses.

In Step 106, the object-designating mechanism is used to designate an object according to the status of the visible driving object. For example, to locate the object according to the coordinate position of the visible driving object, to re-designate an object fitting an action according to the action of the visible driving object, to have the object fitting a word suggestion according to the word suggestion of the visible driving object, to designate another object according to the voice made by the visible driving object, or to designate the object according to any change.

In Step 108, the behavior-designating mechanism can be used to designate an event, a method or a property of the object; i.e., three basic kinds of behaviors. The behavior-designating mechanism can be used to designate one of behaviors according to the status of the visible driving object. For example, when the visible driving object makes a “one click” action, the behavior-designating mechanism can designate the “one click” event. When the visible driving object makes a “clench fist” action, the behavior-designating mechanism can designate the “submit” method. When the visible driving object can make a “flat fist” action, the behavior-designating mechanism designates the property and presents the property value to meet the flat fist of the visible driving object. Furthermore, the behavior-designating mechanism can also base on the position, the appearance, the word suggestion, the voice or any signpost of the visible driving object to designate a behavior.

In Step 110, to manipulate the behavior in a virtual way means to trigger the behavior of the object by an internal program, not by the input device (such as a mouse, a keyboard, a photo pen or a voice diacritical software). For example, a pseudo-event can be an event triggered by the internal program. The virtual manipulation mechanism of the present invention can use a virtual way to trigger the event of the object, to drive the method of the object, or to change the property value of the object. In the present invention, the status of the visible driving object used to designate the object is not necessary the same with the status of the visible driving object used to designate the behavior. For example, the same status can be assigned to the predetermined object and behavior coincidentally, and also different statuses can be assigned to the tpredetermined object and behavior respectively.

In Step 112, when the present invention gets the distinct object recognition and the distinct name of behavior (an event, a method or a property), the present invention can use the program to manipulate the behavior of the object. Because the event, the method and the property can be all manipulated by the internal program not by the input device, such kind of the manipulation can be called a virtual manipulation to be distinct from a real manipulation. In one embodiment of the present invention, the visible driving object can be a virtual figure. If the visual figure moves to a position (x1, y1) at time t1 and does a “one click” action at time t2, the object-designating mechanism designates accordingly an object at position (x1, y1) at time t1 and the behavior-designating mechanism designates also a “one click” event at time t2; such that the visual manipulation mechanism triggers the event of the object at a real time by a virtual way.

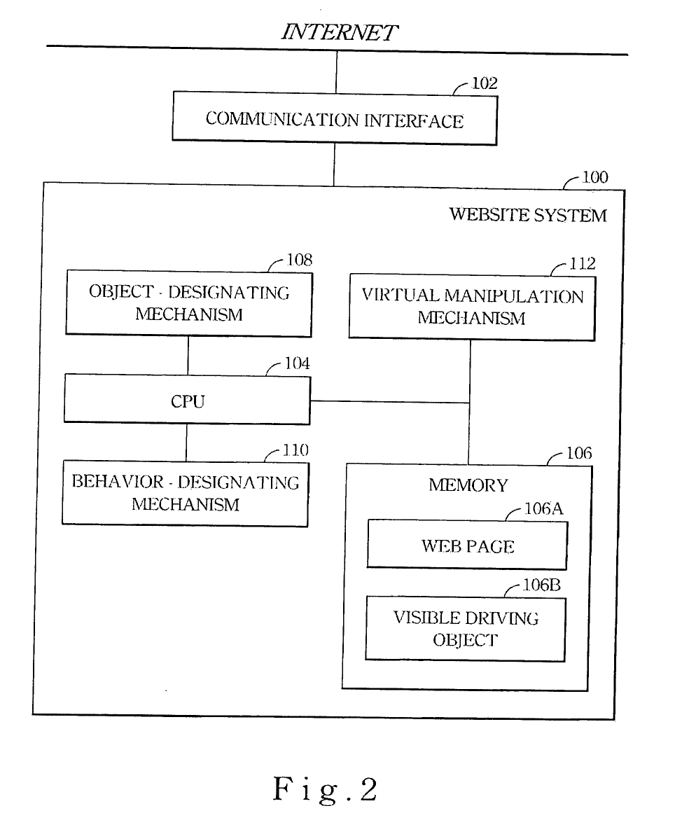

The present invention can also be used to virtually manipulate a web page. One embodiment of the present invention is to provide a website system for virtually manipulating a web page. The web system provides a web page and a visible driving object for downloading to a web browser of a client computer apparatus via Internet. When the visible driving object changes statuses in the web page, the visible driving object can use a virtual way to trigger the event of the object included already in the web page so as to drive the method of the object in the web page or to acquire or to change the property value of the object in the web page. FIG. 2 shows a typical web system architecture of the embodiment in accordance with the present invention. The website system 100 comprises a communication interface 102, a CPU 104, a memory 106, a object-designating mechanism 108, a behavior-designating mechanism 110, and a virtual manipulation mechanism 112. The manipulation of the website system 100 can be described term by term as follows.

The communication interface 102 is used for setting up a communication link, such as an Internet with client computer apparatuses.

The CPU 104 is used for presenting the content of web page and executing calculations among various mechanisms.

The memory 106 is used for at least saving a web page 106A and a visible driving object 106B. The web page 106A is downloaded to the web browser of a client computer apparatus via a communication link through the communication interface 102. The web page 106A can comprise at least an object. The object can comprise at least a behavior. Again, there have three basic kinds of behaviors: events, methods and properties. The visible driving object 106B is also downloaded to the web browser of a client computer apparatus via the communication link through the communication interface 102. The visible driving object 106B has a plurality of statuses and is able to actively change a current status. The statuses of the visible driving object can comprise the coordinate position of the visible driving object, the concrete appearance (such as an action image, a color, or a word suggestion) of the visible driving object, or the voice produced by the visible driving object. To change the current status means to move the position of the visible driving object, to change the appearance of the visible driving object or to make the visible driving object pronounce a voice etc. A program can be used to move the position of the visible driving object so as to change the position status of the visible driving object. The program also can be used to exchange various pictures or animations so as to change the appearance of the visible driving object. The visible driving object can be made as a multimedia object for directly presenting different appearances or different voice statuses.

The object-designating mechanism 108 is downloaded to the web browser via the communication link through the communication interface 102. The object-designating mechanism 108 is used for designating the object according to a status of the visible driving object 106B. The object is comprised in the web page. If the status of the visible driving object were the coordinate position of the visible driving object corresponding to the web browser, the designating method can be as follows:

Setting identification data of the visible driving object to be a DriObj, for example;

Setting a position of the visible driving object in the web page to be a DriObj.left and a DriObj.top;

Setting a Range object—rngObj directing to the coordinate position (DriObj.left, DriObj.top)

An rngObj.parent.id assigned as the identification data of the designated object.

In this embodiment, the object-designating mechanism 108 can also base on the position, the appearance, the word suggestion, the voice or any signpost of the visible driving object 106B to designate an object.

The behavior-designating mechanism 110 can be downloaded to the web browser via the communication link through the communication interface 102. The behavior-designating mechanism 110 is used for designating a behavior according to the status of the visible driving object. The behavior-designating mechanism 110 can be used to designate an event, a method or a property. For example, when the visible driving object 106B makes a “one click” action, the behavior-designating mechanism 110 would designate the “one click” event. When the visible driving object 106B makes a “clench fist” action, the behavior-designating mechanism 110 would designate the “submit” method. When the visible driving object 106B makes a “flat fist” action, the behavior-designating mechanism 110 would designate the property and present the property value upon the flat fist of the visible driving object. Furthermore, the behavior-designating mechanism 110 can also base on the position, the appearance, the word suggestion, the voice or any signpost of the visible driving object 106B to designate a behavior.

The virtual manipulation mechanism 112 can be downloaded to the web browser via the communication link through the communication interface 102. The virtual manipulation mechanism 112 is used for virtually manipulating the behaviors of the objects in the web page. To manipulate the behavior in a virtual way means to trigger the behavior of the object by an internal program, not by the input device (such as a mouse, a keyboard, a photo pen or a voice diacritical software). For example, a pseudo-event is an event triggered by the internal program. The virtual manipulation mechanism can use a virtual way to trigger the event of the object, to drive the method of the object, or to change the property value of the object. In the present invention, three basic kinds of behaviors are events, methods and properties. The virtual manipulation mechanism 112 can be used to trigger the event of the web page, to drive a method of the web page, to acquire or to change a property value of the web page. The detail manipulation method of the present invention can be described as follows:

The visible driving object 106B actively changing a status;

The object-designating mechanism 108 designating an object according to the status of the visible driving object 106B and making identification data of the object to be an ObjID;

The behavior-designating mechanism 110 designating a behavior according to the status of the visible driving object 106B;

When the behavior being an event and the name of the event is EventName, the behavior-designating mechanism 110 using the method of ObjID_EventName( ) to trigger the event of ObjID;

When the behavior being a method and the name of the method being MethodName, the behavior-designating mechanism 110 using the method of ObjID_MethodName( ) to drive the method of ObjID;

When the behavior being a property and the name of the event being PropertyName, the behavior-designating mechanism 110 using the method of ObjValue=ObjID.PropertyName to acquire the property value of ObjID as ObjValue; or using the method of ObjID.PropertyName=ObjValue to change the property value of ObjID to ObjValue.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method to virtually manipulate a digital content which comprises at least one object, comprising at least one behavior, the method at least comprising steps of:
providing a visible driving object in the digital content, the visible driving object having a plurality of statuses and being able to actively change a current status according to an manipulation demand of the digital content;
designating the object according to a first status of the visible driving object;
designating the behavior according to a second status of the visible driving object; and
manipulating virtually the behavior of the object.

2. The method of claim 1, wherein the digital content is a software program.

3. The method of claim 1, wherein the digital content is a teaching document.

4. The method of claim 1, wherein the behavior is selected at least one from a group consisting of an event, a method and a property.

5. The method of claim 1, wherein the plurality of statuses are selected at least one from a group consisting of a location of the visible driving object, an appearance of the visible driving object, and a speech sound of the visible driving object.

6. The method of claim 2, wherein the software program is a teaching software.

7. The method of claim 5, wherein the appearance of the visible driving object is an action.

8. The method of claim 5, wherein the step of designating object is to designate the object according to the position of the visible driving object.

9. The method of claim 7, wherein the step of designating behavior is to designate the behavior according to the action of the visible driving object.

10. The method of claim 1, wherein the first status is different to the second status.

11. The method of claim 1, wherein the first status is identical with the second status.

12. A website system virtually manipulating a web page, for virtually manipulating the web page in a web browser of a client computer apparatus, the website system comprising:
a communication interface for setting up a communication link with the client computer apparatus;
a memory for at least saving the web page and a visible driving object, the web page being displayed on the web browser of the client computer apparatus via the communication link, the web page comprising at least an object, the object comprising at least a behavior, the visible driving object being downloaded to the web browser via the communication link, the visible driving object having a plurality of statuses and being able to actively change a current status according to a manipulation demand of the web page;
a object-desigating mechanism which is downloaded to the web browser via the communication link for designating the object according to a first status of the visible driving object;
a behavior-designating mechanism which is downloaded to the web browser via the communication link for designating the behavior according to a second status of the visible driving object; and
a virtual manipulation mechanism which is downloaded to the web browser via the communication link for virtually manipulating the behavior of the object.

13. The website system of claim 12, wherein the behavior is selected at least one from a group consisting of an event, a method and a property.

14. The website system of claim 12, wherein the plurality of statuses are selected at least one from a group consisting of a location of the visible driving object, an appearance of the visible driving object, and a speech sound of the visible driving object.

15. The website system of claim 14, wherein the appearance of the visible driving object is an action.

16. The website system of claim 14, wherein the object-designating mechanism designates the object according to the position of the visible driving object.

17. The website system of claim 15, wherein the behavior-designating mechanism designates the behavior according to the action of the visible driving object.

18. The website system of claim 12, wherein the first status is different to the second Status.

19. The website system of claim 12, wherein the first status is identical with the second status.
